(19) United States
(12) Patent Application Publication
(10) Pub. No.: US 2021/0310483 A1
(43) Pub. Date: Oct. 7, 2021

(54) UTILITY SINK PUMP

(71) Applicant: GP Enterprises Co., Ltd., Suzhou, Jiangsu (CN)

(72) Inventors: Xian Wang, Suzhou, Jiangsu (CN); Dongyuan Xie, Suzhou, Jiangsu (CN)

(73) Assignee: GP Enterprises Co., Ltd., Suzhou, Jiangsu (CN)

(21) Appl. No.: 16/769,244

(22) PCT Filed: Jul. 29, 2019
(86) PCT No.: PCT/CN2019/098118

§ 371 Date: Jun. 3, 2020

(30) Foreign Application Priority Data
Jun. 28, 2019 (CN) 201910573710.6

(51) Int. Cl. F04B 53/16; F04B 53/22; G01F 1/56

(52) U.S. Cl. CPC F04B 53/16; G01F 1/56; F04B 53/22

(57) ABSTRACT

The present invention discloses a utility sink pump, which comprises a pump body, a detection copper electrode, a hoop device, a locking screw, a junction box, a positioning column, a signal box, and a signal cable. In this way, the utility sink pump of the present invention adopts a non-contact sensor, wherein in an integrated design of the non-contact sensor and the water pump, a copper electrode is used to detect the water flow, since the copper electrode does not contact with water, the cases such as a blockage and a water leakage do not occur, the reliability is high, frequent startup is avoided, and reliable operation can be performed in all the cases of large, medium, and small flow rates, thereby providing good customer experience.

### TECHNICAL FIELD

The present invention relates to the field of water supply systems or flood discharge systems started by a liquid level, in particular to a utility sink pump.

### BACKGROUND OF THE INVENTION

The utility sink pump on the existing market generally uses a diaphragm switch to actuate the water pump to pump water. The pressure introduction hole of the diaphragm switch is easy to be blocked, which causes the water pump to start frequently or fail to operate after startup, thereby affecting the customer experience and causing customer complaints.

### SUMMARY OF THE INVENTION

The primary technical problem solved by the present invention is to provide a utility sink pump which adopts a non-contact sensor, wherein in an integrated design of the non-contact sensor and the water pump, a copper electrode is used to detect the water flow, since the copper electrode does not contact with water, the cases such as a blockage and a water leakage do not occur, the reliability is high, frequent startup is avoided, and reliable operation can be performed in all the cases of large, medium, and small flow rates, thereby providing good customer experience.

In order to solve the above technical problem, a technical solution adopted by the present invention is: providing a utility sink pump, comprising a pump body, a detection copper electrode, a hoop device, a locking screw, a junction box, a positioning column, a signal box, and a signal cable, wherein the detection copper electrode is arranged to abut on an outer surface of a water inlet of the pump body by means of the hoop device and the locking screw that cooperate with each other, the positioning columns are respectively symmetrically arranged at both sides of the water inlet of the pump body, the junction box is arranged at one side of the water inlet by means of the positioning column and is located opposite the detection copper electrode, the signal box is arranged at the other side of the water inlet by means of the positioning column and is connected to the detection copper electrode, and the signal cable is seal-connected to the junction box and the signal box respectively.

In a preferred embodiment of the present invention, the detection copper electrode comprises a copper electrode and a detection circuit board, and the copper electrode and the detection circuit board are welded and connected together.

In a preferred embodiment of the present invention, the periphery of the copper electrode is wrapped with a layer of rubber.

In a preferred embodiment of the present invention, the hoop device comprises a rubber hoop ring, a left connecting strip, a right connecting strip, a nut groove, a strip column, and a positioning column, the left connecting strip and the right connecting strip are respectively movably arranged at left and right sides of the rubber hoop ring, the nut grooves are respectively arranged at front ends of the left connecting strip and the right connecting strip, the strip columns are respectively transversely arranged at outer sides of the nut grooves, and the positioning columns are respectively arranged at the front ends of the left connecting strip and the right connecting strip.

In a preferred embodiment of the present invention, the rubber hoop ring has a semicircular structure.

In a preferred embodiment of the present invention, the left connecting strip and the right connecting strip have the same arc structure.

In a preferred embodiment of the present invention, the junction box comprises a box body, a box cover, a junction box sealing ring, and a circuit board, the box cover is arranged at a back end of the box body, the box cover is provided with a sealing ring groove therein, the junction box sealing ring is arranged in the sealing ring groove, and the circuit board is arranged between the box body and the box cover.

In a preferred embodiment of the present invention, one side of the box body is further provided with a power cord through hole, and a power cord is mounted in the power cord hole.

In a preferred embodiment of the present invention, front ends of the junction box and the signal box are both provided with semicircular notches, and the semicircular notches are used cooperatively with the water inlet of the pump body.

In a preferred embodiment of the present invention, both ends of the signal cable are provided with sealing plugs, and the sealing plugs are respectively inserted into sealing holes of the signal box and the junction box.

The present invention has the following beneficial effects: the utility sink pump of the present invention adopts a non-contact sensor, wherein in an integrated design of the non-contact sensor and the water pump, a copper electrode is used to detect the water flow, since the copper electrode does not contact with water, the cases such as a blockage and a water leakage do not occur, the reliability is high, frequent startup is avoided, and reliable operation can be performed in all the cases of large, medium, and small flow rates, thereby providing good customer experience.

### BRIEF DESCRIPTION OF THE FIGURES

In order to explain the technical solution in the embodiments of the present invention more clearly, the drawings required by the description of the embodiments are briefly described below. It is obvious that the drawings in the description below are merely some embodiments of the present invention, and for those skilled in the art, other drawings can also be obtained from these drawings without creative work, where:

FIG. 1 is a structural schematic diagram of a utility sink pump in a preferred embodiment of the present invention;

FIG. 2 is an assembly schematic diagram in another view angle of a junction box in FIG. 1; and

FIG. 3 is a structural schematic diagram of a hoop device in FIG. 1.

The marks in the drawings are: 1. pump body, 2. detection copper electrode, 3. hoop device, 4. locking screw, 5. junction box, 6. positioning column, 7. signal box, 8. signal cable, 9. water inlet, 10. sealing plug, 11. sealing hole, 12. mounting hole, 21. copper electrode, 22. detection circuit board, 31. rubber hoop ring, 32. left connecting strip, 33. right connecting strip, 34. nut groove, 35. strip column, 36. positioning column, 501. box body, 502. box cover, 503. junction box sealing ring, 504. circuit board, 505 sealing ring groove, 506. power cord hole, 507. power cord, 508. screw column, 509. screw, 510. circuit board hole, 511. through hole, 512. screw, 513. convex column.

### DETAILED DESCRIPTION

The technical solution in the embodiments of the present invention are described clearly and completely below. Obviously, the described embodiments are merely a part of the embodiments of the present invention, not all of the embodiments. Based on the embodiments in the present invention, all other embodiments obtained by those skilled in the art without creative work shall fall within the scope of protection of the present invention.

As shown in FIG. 1, an embodiment of the present invention includes:

A utility sink pump includes a pump body 1, a detection copper electrode 2, a hoop device 3, a locking screw 4, a junction box 5, a positioning column 6, a signal box 7, and a signal cable 8. The detection copper electrode 2 is arranged to abut on an outer surface of a water inlet 9 of the pump body 1 by means of the hoop device 3 and the locking screw 4 that cooperate with each other, the positioning columns 6 are respectively symmetrically arranged at both sides of the water inlet 9 of the pump body 1, the junction box 5 is arranged at one side of the water inlet 9 by means of the positioning column 6 and is located opposite the detection copper electrode 2, the signal box 7 is arranged at the other side of the water inlet 9 by means of the positioning column 6 and is connected to the detection copper electrode 2, and the signal cable 8 is seal-connected to the junction box 5 and the signal box 7 respectively.

In the above description, the detection copper electrode 2 includes a copper electrode 21 and a circuit board 22, and the copper electrode 21 and the detection circuit board 22 are welded and connected together. The periphery of the copper electrode 21 is wrapped with a layer of rubber (not shown in the figure) for protecting the copper electrode 21.

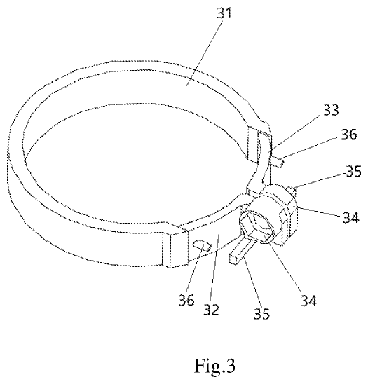

As shown in FIG. 3, the hoop device 3 includes a rubber hoop ring 31, a left connecting strip 32, a right connecting strip 33, a nut groove 34, a strip column 35, and a positioning column 36, the left connecting strip 32 and the right connecting strip 33 are respectively movably arranged at left and right sides of the rubber hoop ring 31, the nut grooves 34 are respectively arranged at front ends of the left connecting strip 32 and the right connecting strip 33, the strip columns 35 are respectively transversely arranged at outer sides of the nut grooves 34, and the positioning columns 36 are respectively arranged at the front ends of the left connecting strip 32 and the right connecting strip 33.

The rubber hoop ring 31 has a semicircular structure; and the left connecting strip 32 and the right connecting strip 33 have the same arc structure. The rubber hoop ring 31, the left connecting strip 32, and the right connecting strip 33 form a circular structure that matches and sleeve-mounted on the outer surface of the water inlet 9 of the pump body 1.

The nut groove 34 is used to accommodate the locking screw 4. In the embodiment, the interior of the rubber hoop ring 31 is wrapped with rubber, so as to avoid damage to the detection copper electrode 2. The hoop device 3 with rubber locks the detection copper electrode 2 to the water inlet 9 of the water pump 1 by means of the locking screw 4, and the hoop device 3 is positioned by means of the two positioning columns 6, where the position does not change during assembly.

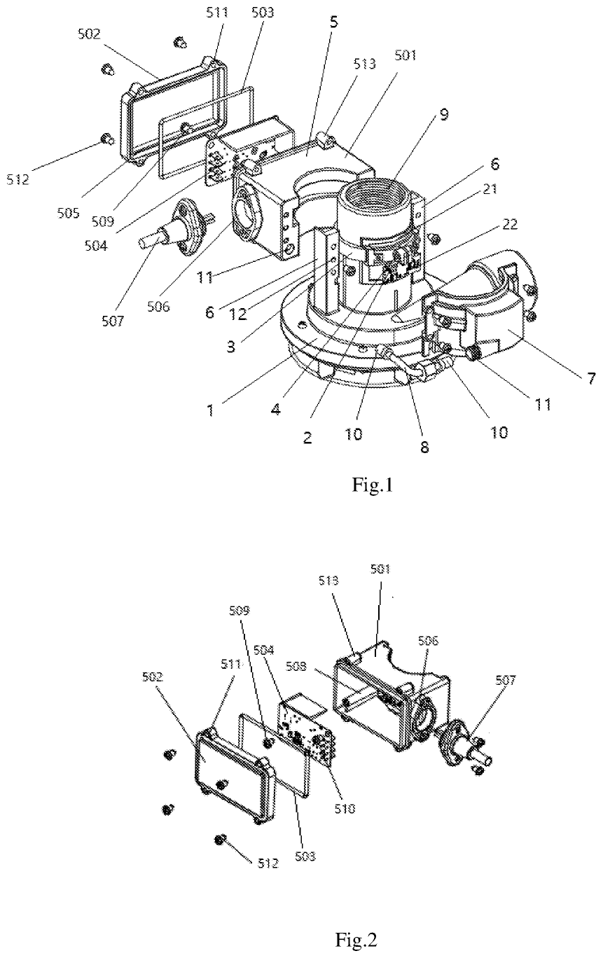

As shown in FIG. 1 and FIG. 2, the junction box 5 includes a box body 501, a box cover 502, a junction box sealing ring 503, and a circuit board 504. The box cover 502 is arranged at a back end of the box body 501, the box cover 502 is provided with a sealing ring groove 505 therein, the junction box sealing ring 503 is arranged in the sealing ring groove 505, and the circuit board 504 is arranged between the box body 501 and the box cover 502.

In the above description, one side of the box body 501 is further provided with a power cord hole 506, and a power cord 507 is mounted in the power cord hole 506.

In addition, two screw columns 508 are provided inside the junction box 5, the screw column 508 is provided with a screw hole therein, and a screw 509 pass through a circuit board hole 510 on the circuit board 504 to fix the circuit board 504 to the screw column 508.

Four through holes 511 are provided in the box cover 502 that is provided with the sealing ring groove 505 therein, the junction box sealing ring 503 is fixed into the sealing ring groove 505, a screw 512 passes through the through hole 511 to fix the box cover 502 to a convex column 513 of the box body 501.

In the embodiment, front ends of the junction box 5 and the signal box 7 are both provided with semicircular notches, and the semicircular notches are used cooperatively with the water inlet 9 of the pump body 1.

The signal cable 8 passing through the signal box 7 is used to connect a detection circuit of the detection copper electrode 2 and a switch circuit in the junction box 5. Both ends of the signal cable 8 are provided with sealing plugs 10, and the sealing plugs 10 are respectively inserted into sealing holes 11 of the signal box 5 and the junction box 7, playing a waterproof role.

The positioning column 6 is provided with a plurality of mounting holes 12, the junction box 5 and the signal box 7 are provided with a plurality of screw holes, and the signal box 7 is locked to the positioning column 6 by means of a screw passing through the mounting hole 12 and being self-tapping in the screw hole of the junction box 5.

In conclusion, the utility sink pump of the present invention adopts a non-contact sensor, where in an integrated design of the non-contact sensor and the water pump, a copper electrode is used to detect the water flow, since the copper electrode does not contact with water, the cases such as a blockage and a water leakage do not occur, the reliability is high, frequent startup is avoided, and reliable operation can be performed in all the cases of large, medium, and small flow rates, thereby providing good customer experience.

The above description is only an embodiment of the present invention, and does not intend to limit the scope of the patent of the present invention. Any change of equivalent structure or equivalent process made by using the description of the present invention, or direct or indirect application in other related technical fields, likewise falls with the scope of patent protection of the present invention.

What is claimed is:

1. A utility sink pump, comprising a pump body, a detection copper electrode, a hoop device, a locking screw, a junction box, a positioning column, a signal box, and a signal cable, wherein the detection copper electrode is arranged to abut on an outer surface of a water inlet of the pump body by means of the hoop device and the locking screw that cooperate with each other, the positioning columns are respectively symmetrically arranged at both sides of the water inlet of the pump body, the junction box is arranged at one side of the water inlet by means of the positioning column and is located opposite the detection copper electrode, the signal box is arranged at the other side of the water inlet by means of the positioning column and is connected to the detection copper electrode, and the signal cable is seal-connected to the junction box and the signal box respectively.

2. The utility sink pump according to claim 1, wherein the detection copper electrode comprises a copper electrode and a detection circuit board, and the copper electrode and the detection circuit board are welded and connected together.

3. The utility sink pump according to claim 2, wherein the periphery of the copper electrode is wrapped with a layer of rubber.

4. The utility sink pump according to claim 1, wherein the hoop device comprises a rubber hoop ring, a left connecting strip, a right connecting strip, a nut groove, a strip column, and a positioning column, the left connecting strip and the right connecting strip are respectively movably arranged at left and right sides of the rubber hoop ring, the nut grooves are respectively arranged at front ends of the left connecting strip and the right connecting strip, the strip columns are respectively transversely arranged at outer sides of the nut grooves, and the positioning columns are respectively arranged at the front ends of the left connecting strip and the right connecting strip.

5. The utility sink pump according to claim 4, wherein the rubber hoop ring has a semicircular structure.

6. The utility sink pump according to claim 5, wherein the left connecting strip and the right connecting strip have the same arc structure.

7. The utility sink pump according to claim 4, wherein the junction box comprises a box body, a box cover, a junction box sealing ring, and a circuit board, the box cover is arranged at a back end of the box body, the box cover is provided with a sealing ring groove therein, the junction box sealing ring is arranged in the sealing ring groove, and the circuit board is arranged between the box body and the box cover.

8. The utility sink pump according to claim 7, wherein one side of the box body is further provided with a power cord through hole, and a power cord is mounted in the power cord hole.

9. The utility sink pump according to claim 1, wherein front ends of the junction box and the signal box are both provided with semicircular notches, and the semicircular notches are used cooperatively with the water inlet of the pump body.

10. The utility sink pump according to claim 1, wherein both ends of the signal cable are provided with sealing plugs, and the sealing plugs are respectively inserted into sealing holes of the signal box and the junction box.
